(19) United States
(12) Patent Application Publication
(10) Pub. No.: US 2014/0361580 A1
(43) Pub. Date: Dec. 11, 2014

(54) Collapsible Truck Trailer

(71) Applicant: Michael Patrick Flynn, Durango, CO (US)

(72) Inventor: Michael Patrick Flynn, Durango, CO (US)

(21) Appl. No.: 13/910,681

(22) Filed: Jun. 5, 2013

(51) Int. Cl. B60P 1/02; B62D 35/00

(52) U.S. Cl. CPC B60P 1/02; B62D 35/001
USPC 296/180.3; 296/182.1

(57) ABSTRACT

A collapsible truck trailer comprises an upper container that houses, and is slidably engaged with, a primary container via a lifting mechanism and vertical guide rails. The lifting mechanism changes trailer between a collapsed configuration wherein the upper container completely houses the primary container, and an extended configuration wherein the upper container is completely above the primary container. The vertical guide rails comprise a vertical c-channel fixed to the upper container that is slidably engaged with a complementary vertical rail fixed to the primary container. The lifting mechanism includes a series of intersecting lift arms driving by a motor and actuator. An automatically adjusting wind guard covers the front side of the upper container to reduce wind drag. The wind guard has a base portion connected to the truck roof and a flat portion having a terminal end that rests upon the upper container.

### RELATED U.S. APPLICATION DATA

This application claims priority to Provisional Application No. 61/655,487, filed Jun. 5, 2012.

### FIELD OF THE INVENTION

The present invention relates to trailers used in tractor-trailer combinations.

### BACKGROUND OF THE INVENTION

Trucking is a dominant part of the commercial freight industry in the United States. In the freight industry, over 58 percent of the nation's freight (by weight) and over 64 percent (by value) is hauled by trucks on the nation's highways and freeways. Every year, semi-trailer trucks (or tractor-trailers) haul freight over billions of miles in the U.S. alone. Safety and cost are primary concerns in the trucking industry. With respect to safety, the truck trailers have a profile that is both tall and wide, which presents a very large flat surface. This large surface cause the truck to experience large forces during windy conditions, which can easily sway the truck, cause the drive to “jack-knife,” or directly knock the truck over. This undesirable effect can arise from weather or the inherent geography of certain areas. Such occurrences can result motorist injuries or fatalities, as well as significant damage to the vehicles and cargo. When truck trailers are empty or hauling minimal cargo, the effect of wind forces is increased considerably because the truck does not have the weight of the cargo to stabilize it and counteract the forces exerted by the wind.

With the dramatic increase in fuel costs, conservation of fuel is also a major concern. The trailer's large profile experiences wind drag during hauling, and the drag is a constant force that reduces fuel efficiency because the truck is using a portion of its energy (and thus fuel) to overcome wind drag. The effect of wind drag is increase when driving into the wind or during stormy conditions. Thus, there is a great need to increase the safety and fuel-efficiency associated with tractor-trailer operation.

### SUMMARY OF THE INVENTION

A collapsible truck trailer provides an adjustable two-tiered solution for safer and more efficient large scale product transport. The trailer includes an upper container that is configured to house, and engaged with, a primary container via a lifting mechanism and vertical guide rails located at the back of the containers. The lifting mechanism comprises a motor that actuates a series of intersecting lift arms to raise or lower the upper container between a collapsed position and an extended position. The lifting mechanism lifts and lowers the upper container via four pairs of scissor-type lift arms that connect the primary container to the upper container. A base end of the lift arms is connected with the primary container and the motor, while the upper end of the lift arms is connected to the upper container. The collapsible truck trailer also includes an automatically adjusting wind guard that reduces wind drag force on the front face of the upper container. Upon unloading the contents of the primary container and the upper container, the upper container can be lowered or collapsed via the lifting mechanism in order to reduce the trailer profile and wind drag. In the collapsed position, the primary container is completely housed within the upper container.

A pair of vertical guide rails at the back of the containers allow the upper container to slide over the primary container and provide lateral stability by dictating the vertical path that the upper container takes when be extended and collapsed. The lifting mechanism is powered by a motor that actuates the lift arms via a drive belt, drive shaft, and motorized actuator, which are all located on the underside of the primary container. Via the actuator, the motor pushes and pulls the base ends of the intersecting lift arms horizontally which lifts the opposing end of the lift arms along with the upper container. By extending the trailer height by extending the upper container, substantially more cargo can be transported and once the cargo is unloaded the upper container can be collapsed to the size of a standard trailer. This system effectively eliminates the undesirable effects of wind drag that would be associated with a taller trailer, thus improving fuel economy and safety. Moreover, when in the collapsed position, the weight of the upper container increased the weight and density of the trailer, making it less prone to movement by wind forces.

### BRIEF DESCRIPTION OF THE DRAWINGS

FIG. 1 illustrates a perspective view of the collapsible truck trailer in an extended position.

FIG. 2 illustrates a perspective view of the collapsible truck trailer in a collapsed position.

FIG. 3 illustrates a bottom perspective view of the collapsible truck trailer and motorized scissor lifting hardware.

FIG. 4 illustrates a close-up perspective view of the back side of the collapsible truck trailer in the extended position.

FIG. 5 illustrates a rear view of the collapsible truck trailer in the extended position.

FIG. 6 illustrates a profile view of the collapsible truck trailer in the extended position with the wind guard in its functional position.

FIG. 7 illustrates a profile view of the collapsible truck trailer in the collapsed position with the wind guard in its non-functional position.

FIG. 8 illustrates a close-up perspective view of the collapsible truck trailer in the extended position, with the wind guard in its functional position

### DETAILED DESCRIPTION

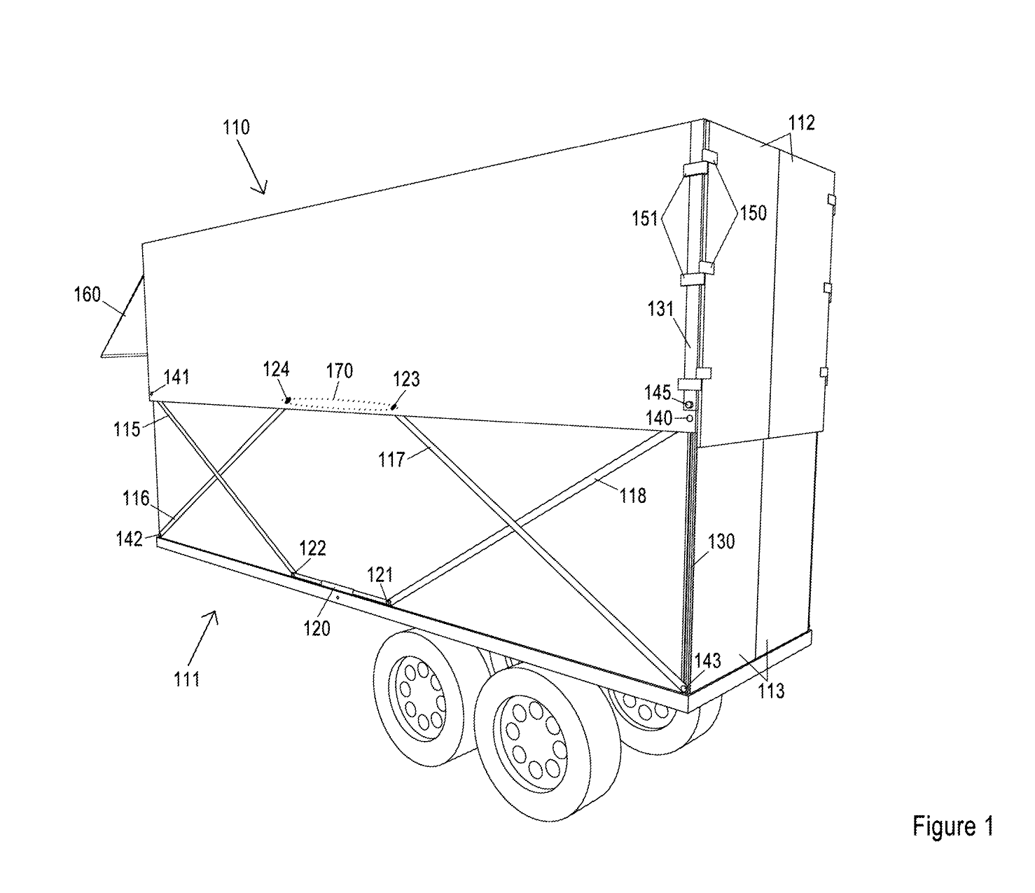

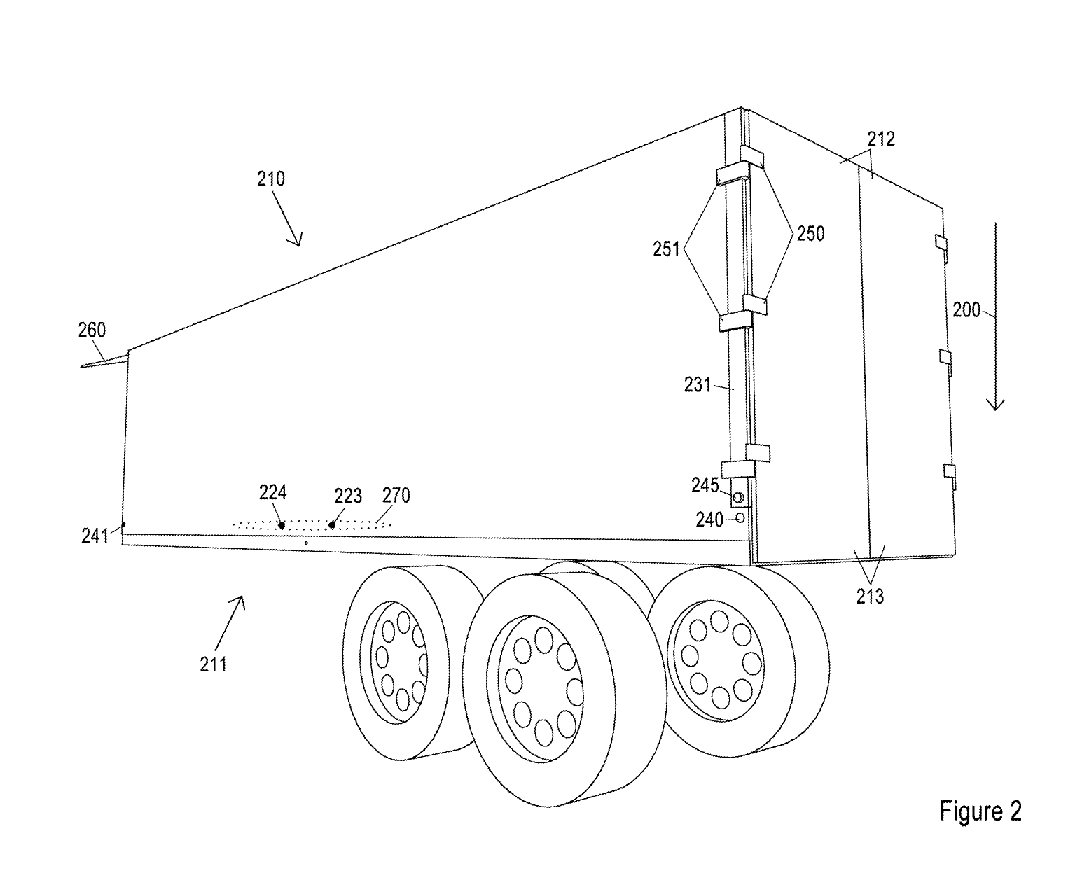

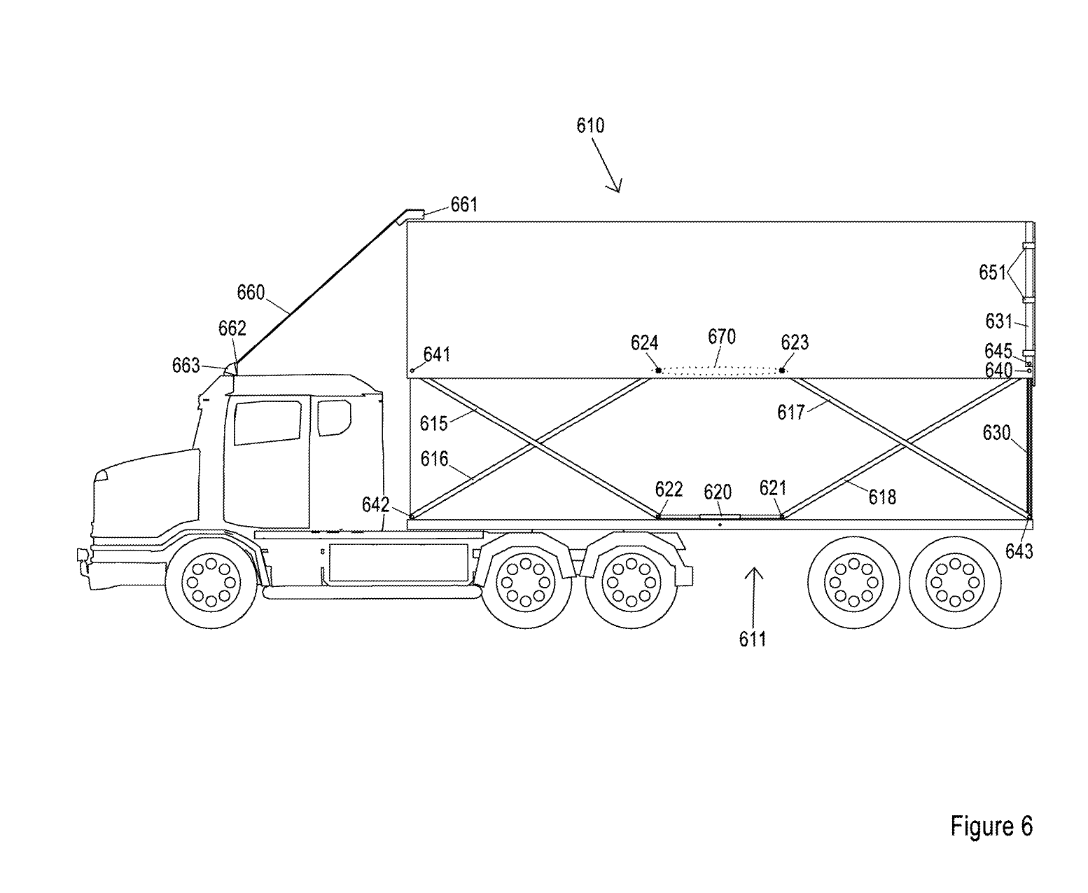

FIG. 1 illustrates a perspective view of the collapsible truck trailer in a raised or extended position. In this configuration, the trailer can hold a substantially greater amount of cargo as compared to a standard trailer that only has the cargo volume of the primary container 111. The ability to haul a larger amount of cargo can be a critical advantage in many hauling scenarios. The collapsible truck trailer comprises a collapsible upper container 110, a primary storage container 111, and a wind guard 160. The collapsible upper container 110 is configured to house the primary storage container 111 when the truck trailer is on a non-extended or collapsed position as shown in FIG. 2 (i.e. when the upper container 110 is lowered). By way of spatial reference, the wind guard 160 is located on a front side of the upper container 110. As described in connection with FIG. 6, the wind guard 160 acts to reduce undesirable drag forces caused by the wind hitting the front of the upper container when the trailer is in the extended position. In FIG. 1, the front sides of the upper container 110 and primary container 111 are not shown and are facing away from the viewer. The front side of the upper container 110 is parallel to a back side of the upper container that is on the other end of the upper container 110 (shown in FIG. 1). The back side of the upper container 110 contains doors 112 that are used to access the container. Similarly, primary container 111 has doors 113. The front and back sides of the containers connect with, and are perpendicular to, the long sides of the containers.

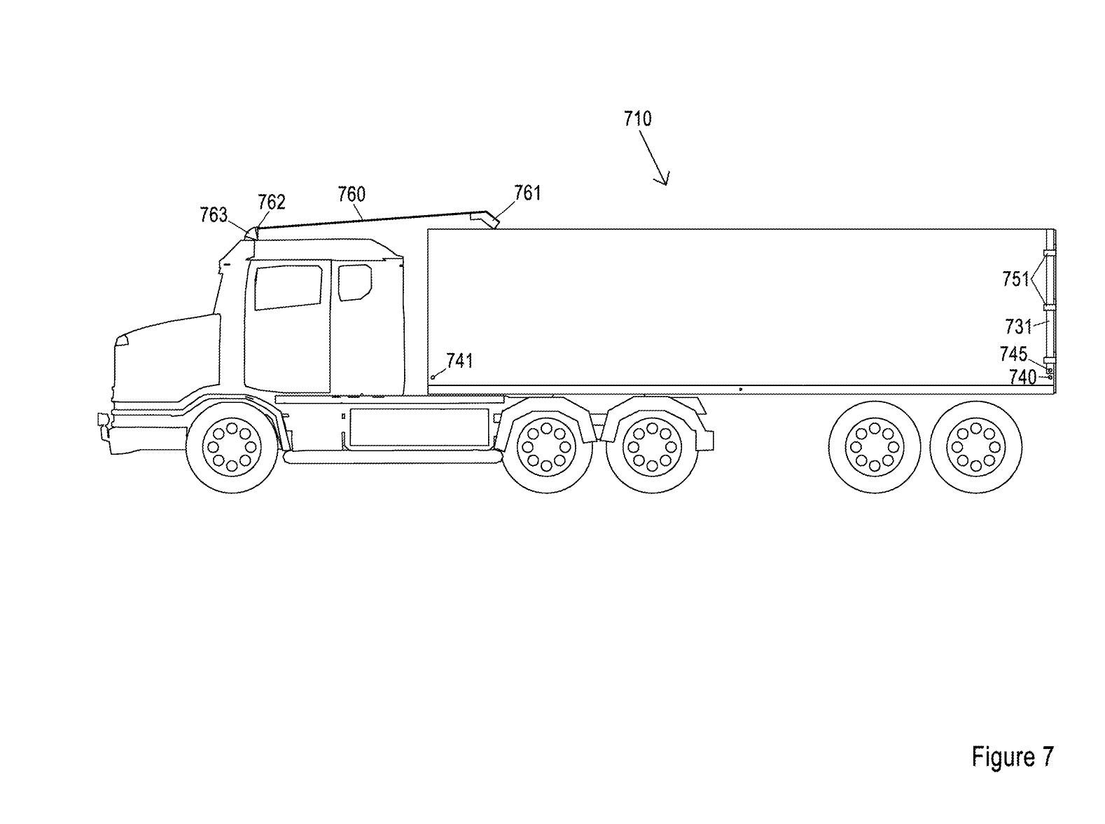

A standard truck cab (shown in FIGS. 6 and 7) carries the containers on its truck bed. The upper container 110 is raised and lowered by a lifting mechanism that comprises a motorized scissor-lift mechanism, the majority of which resides in the underside and long sides of primary container 111 (i.e. the large facades running perpendicular to the aforementioned front and back sides). The scissor lift mechanism comprises four pairs of intersecting lift arms, with two pairs of lift arm on each of the two long sides of the primary container 111. FIG. 1 shows two pairs of intersecting lift arms, i.e. lift arms 115-116 and 117-118. A corresponding set of lift arms is found on the opposing long side of the primary container 111 (not shown). In the extended position, the intersecting lift arms run diagonally along both long sides of the primary container. The intersecting lift arms are rotatably attached to both the primary container 111 and upper container 110 via fixed pivot points 140-143.

Fixed pivot points 140 and 141 attach the lift arms to the upper container 110, while fixed pivot points 142 and 143 attach the lift arms to the corners of the primary container 111. During the collapse of the upper container 110, the upper ends of the intersecting lift arms utilize passive, sliding pivot points 123 and 124 to move a small horizontal distance within pivot track 170. This motion corresponds to the varying distances between fixed and sliding pivot points. The movement of the lift arms, and extension of the upper container 110 is driven by motorized actuator 120 which pushes/pulls lift arms 115 and 118 via drive pivot points 121 and 122 (attached to the bottom ends of lift arms 115 and 118), respectively. Thus the motorized actuator 120 directly actuates four lifting arms, i.e. lifting arms 115 and 118 as well as their corresponding lifting arms on the opposite side of the primary container (not shown). Both the upper and primary containers possess vertical c-channel hardware at the back of the trailer. These rail channels ensure a smooth raising and lowering motion having minimal lateral movement. Support rail 130 runs along the vertical height of the primary container 111 and engages with c-channel beam 131 on upper container 110. C-channel beam 131 is attached to the upper container 110 via support bolt 145.

The interiors of the upper container and primary container can be accessed via the doors at back side of the upper and primary containers, i.e. upper doors 112 and primary doors 113, respectively. The upper container doors 112 utilize door hinges 150 (on the back of the container) and door hinges 151 (on the long side of the container) which hingedly connect the doors 112 to the upper container 110. Thus, the door hinges 150 and 151 facilitate the opening and closing of the doors 112. The primary container doors 113 are internal, i.e. within the container, and thus not shown in the view of FIG. 1. The door hinges on the primary container doors 113 are internal so that the upper container 110 can be sized to be only slightly larger than the primary container 111 while easily extending and collapsing around the primary container 111. If the door hinges were on the outside of the primary container as is conventionally done, the upper container would need to be made larger to provide adequate clearance for the door hinges, which is visually and mechanically undesirable.

FIG. 2 illustrates a perspective view of the collapsible truck trailer in a lowered or collapsed position. The trailer is placed in this configuration once the cargo in the containers is either completely emptied, or emptied to the point that the cargo fits within the primary container such that the extension of the upper container is not necessary. As is apparent, the trailer has a much lower profile, and will experience less wind drag, in the collapsed position. The upper container 210 is lowered via the motorized scissor lift mechanism, as indicated by motion arrow 200, and now completely houses the primary container 211. The collapsed position of sliding pivot points 223 and 224 (which are bolted to the intersecting lift arms) reflects the downward path of the intersecting lift arms (not shown as they are covered by the upper container 210), which are now horizontal and in close proximity to the bottom edge of primary container 211. When the lift mechanism is collapsed, the pivot points 223 and 224 are in closer proximity to each other, as seen in the comparison of FIG. 1 and FIG. 2. The intersecting lift arms now run horizontally instead of diagonally with respect to the long side of the container. The intersecting lift arms are parallel to the large side facades of the long sides of the trailer, and are perpendicular to the front and back sides of the trailer. The upper container 210 now has a considerably lower height than in the extended position, and completely covers or houses the primary container 211.

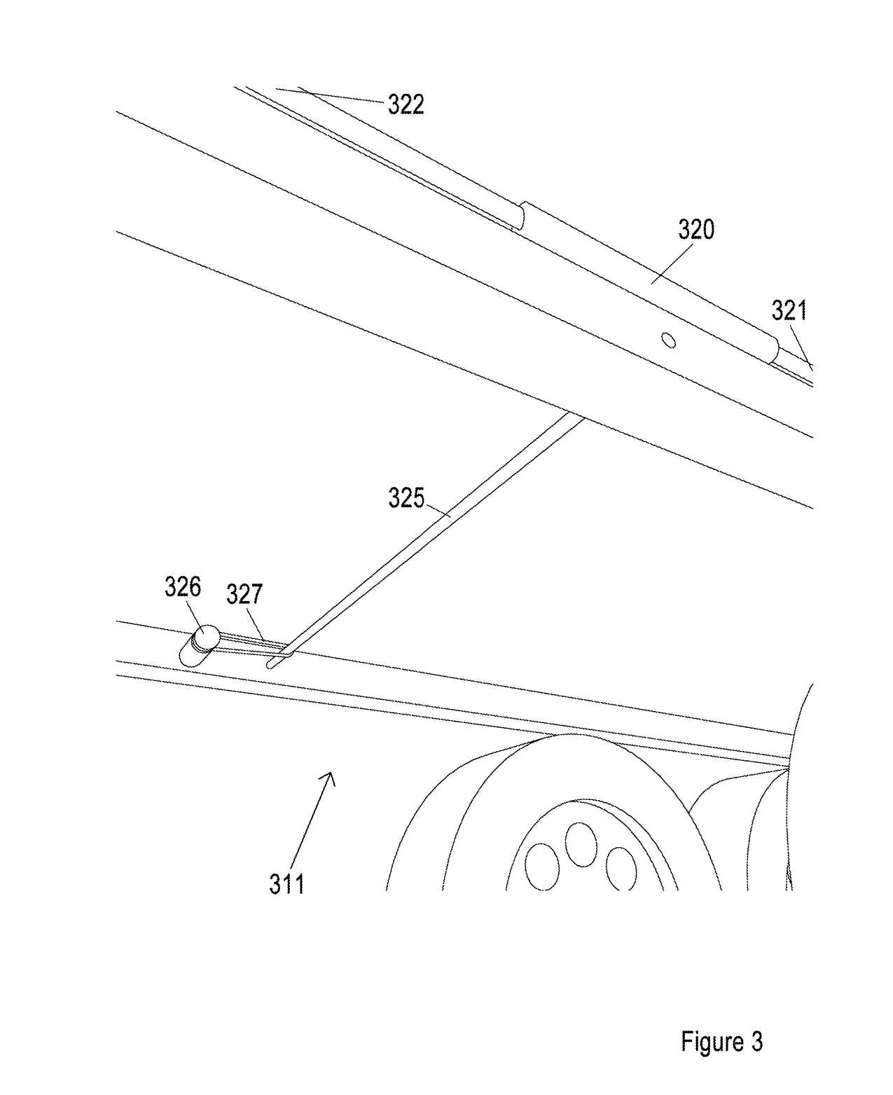

FIG. 3 illustrates a bottom perspective view of the collapsible truck trailer and the components of the motorized scissor lift mechanism. The lift mechanism comprises an electric motor 326, a drive belt 327, a drive shaft 325, a motorized actuator 320, and drive pivot points 321 and 322. The drive shaft 325 runs along the entire bottom width of the primary container 311, perpendicular to the long sides of the container. The electric motor 326, a drive belt 327, and drive shaft 325 are preferably positioned in the center of the trailer, i.e. the center of primary container 311. The shaft engages with two actuators 320 that are located on opposing sides of the trailer (only one side and actuator is shown). The shaft is driven to rotate by the motor 326 and belt 327 which wraps around the shaft and transfers its rotation to it as a result of being rotated by the spinning of the electric motor. The drive shaft's ensuing rotation drives the actuator 320 to collapse and expand the drive pivot points 321 and 322 as desired. The result is an upper container 311 that is adjustable in height, as these drive pivot points 321 and 322 are attached to the intersecting lift arms. By dictating the horizontal positions of the intersecting lift arms' pivot points, the electric motor dictates the height of the collapsible upper container 311.

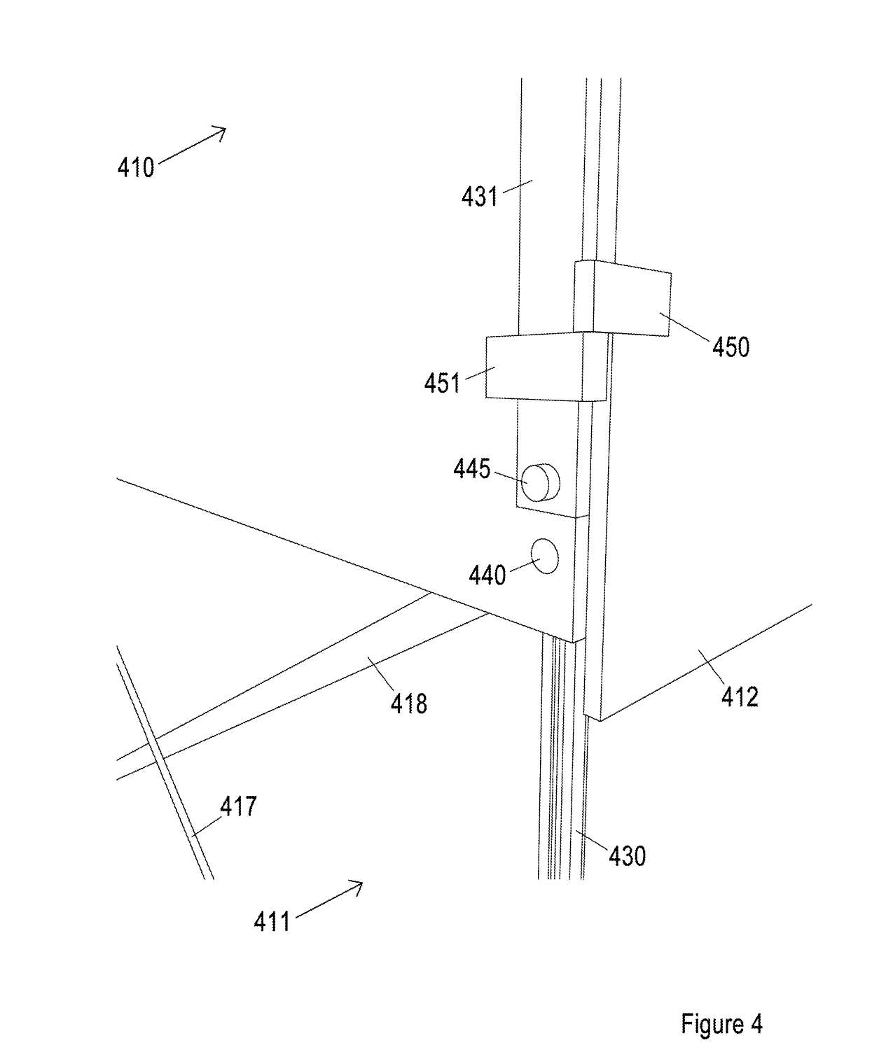

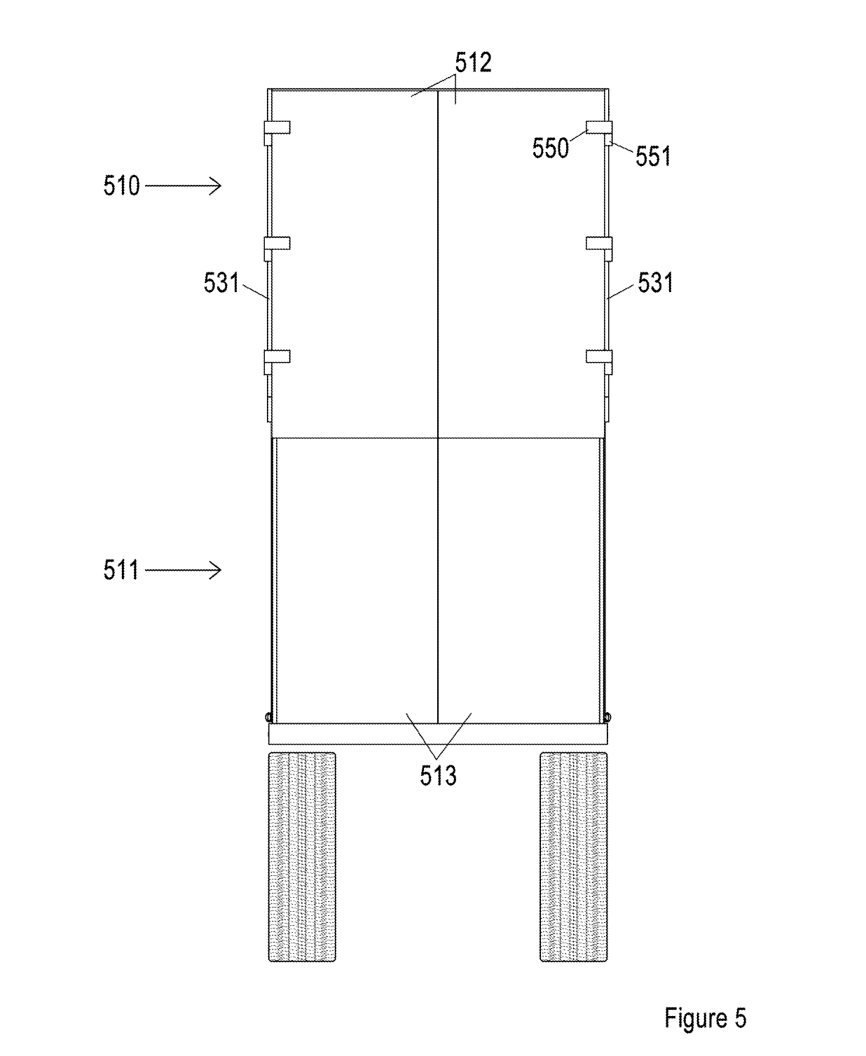

FIG. 4 illustrates a close-up perspective view of the back corner of the collapsible truck trailer with the upper container 410 in the extended position. The figure depicts c-channel beam 431, c-channel rail 430, and intersecting lift arms 417 and 418. The c-channel beam 431 (i.e. support beam 431) engages with, and slides along, the c-channel rail 430 (i.e. support rail 430). This dual c-channel support mechanism allows the upper container to be easily raised and lowered while remaining engaged with the primary container in a stable manner. During raising and lowering of the upper container, the support beam 431 and support rail 430 provide lateral support. The result is the reduction of horizontal or lateral shaking caused by the collapsing or expansion of the upper container. Support bolt 445 connects the bottom of c-channel beam 431 to the upper container 410. The support beam 431 and support rail 430 are collectively referred to as the “vertical guide rails.” Fixed pivot point 440 connects the intersecting bar 418 to the upper container 410 and thereby transfers force to the upper container 410. FIG. 5 illustrates a rear view of the back side of the collapsible truck trailer in the extended position. Included in this view is the upper container 510 with doors 512, primary container 511 with doors'513. The upper container 510 further comprises door hinges 550 and 551 and c-channel support beams 531.

FIG. 6 illustrates a profile view of the collapsible truck trailer in the extended position with the wind guard 660 in its functional position. This position is referred to as the functional position because it is the position in which the wind guard serves its primary function of reducing wind drag. When the upper container 610 is in the extended position, it protrudes vertically well beyond the height of the truck and is completely above primary container 611. This large flat surface (i.e. front side) directly catches the wind and presents considerable drag forces, i.e. forces in the direction opposite to the truck's motion caused by the wind hitting the front side of the upper container 610. This drag force is undesirable because it counters the motion of the truck, which reduces fuel economy and increases travel time and cost. Moreover, wind drag is dangerous because it exerts significant forces upon the trailer that can physically move the truck and trailer, potentially causing the tractor trailer to swerve or flip on its side. Wind guard 660 minimizes this drag force because it deflects the wind at an angle (e.g. 45 degrees) to allow it to more easily flow over the upper container without a vertical surface to push against.

The wind guard comprises a flat body portion 660, a base portion 663, a pivot point 662, and a contact pad 661. The flat body portion is rigid and flat, and may take the shape of the rectangle or trapezoid. The wind guard base portion 663 is fixed to the roof of the truck cab. The terminal end of the wind guard body 660 contains the contact pad 661 that rests of the surface of the upper container. The contact pad 661 provides a non-abrasive contact between the wind guard and the surface of the upper container, which reduces damage and noise caused by the contact between the wind guard and the upper container during hauling and raising/lowering the of wind guard. Within the base portion 663 contains a torsion spring that is fixed to the wind guard body portion 660 and exerts a constant downward force on the body portion 661. This downward force keeps the wind guard resting on the upper container 610 at all times, regardless of the height of the upper container. The pivot joint 662 allows the wind guard body 660 to rotate upward and downward at different angles (i.e. the pivot joint 662 provides a range of motion for the wind guard). Thus, the position and angle of the wind guard automatically adjusts to the height of the upper container. In an exemplary embodiment, the wind guard is made of fiberglass.

Also shown in FIG. 6 are the two pairs of intersecting lift arms, i.e. lift arms 615-616 and 617-618 which run diagonally along both long sides of the primary container. A corresponding set of lift arms is found on the opposing long side of the primary container 611 (not shown). The intersecting lift arms are attached to both the primary container 611 and upper container 610 via fixed pivot points 640-643. Fixed pivot points 640 and 641 attach the lift arms to the upper container 610, while fixed pivot points 642 and 643 attach the lift arms to the corners of the primary container 611. During the collapse of the upper container 610, the upper ends of the intersecting lift arms utilize passive, sliding pivot points 623 and 624 to move a small horizontal distance within pivot track 670. This motion corresponds to the varying distances between fixed and sliding pivot points. The movement of the lift arms, and extension of the upper container 610 is driven by motorized actuator 620 which pushes/pulls lift arms 615 and 618 via drive pivot points 621 and 622 (attached to the bottom ends of lift arms 615 and 618), respectively. Both the upper and primary containers possess vertical c-channel hardware at the back of the trailer. These rail channels ensure a smooth raising and lowering motion having minimal lateral movement. Support rail 630 runs along the vertical height of the primary container 611 and engages with c-channel beam 631 on upper container 610. C-channel beam 631 is attached to the upper container 610 via support bolt 645.

FIG. 7 illustrates a profile view of the collapsible truck trailer in lowered, collapsed position with the wind guard in its relatively non-functional position. As a result of collapsing the upper container 710 of the trailer, the wind guard 760 is automatically lowered due to the spring force exerted by the torsion spring in the base portion 763. As described above, the base portion 763 of the wind guard contains a torsion spring that exerts a downward force on the wind guard body 760, which keeps the wind guard body 760 in contact with the upper container 710 via contact pad 761. Also shown are fixed pivot points 740 and 741 which attach the lift arms (which are collapsed and not in view) to the upper container 110, door hinges 751, and c-channel beam 731 with attachment bolt 745. Because the upper container is collapsed and not protruding above the height of the primary container and truck, the upper container does create an undesirable drag force in this position. However, to the extent the height of the upper container 710 extends above the roof of the truck, the wind guard serves its purpose of reducing drag. Moreover, the wind guard 760 still serves a more minor aerodynamic benefit in the collapsed position even when the upper container is not taller than the truck, because it prevents air from flowing over the truck roof and down against the front side of the primary container to cause a drag force. This phenomenon is more present and pronounced at high speeds and in windy conditions. In this scenario, the wind guard 760 acts as an air damn to prevent air from flowing over the truck in don in to the space between the truck and the container to push against he vertical surface of the container during driving. Thus, even in the non-functional position, the wind guard 760 serves to reduce wind drag and improve fuel economy and safety.

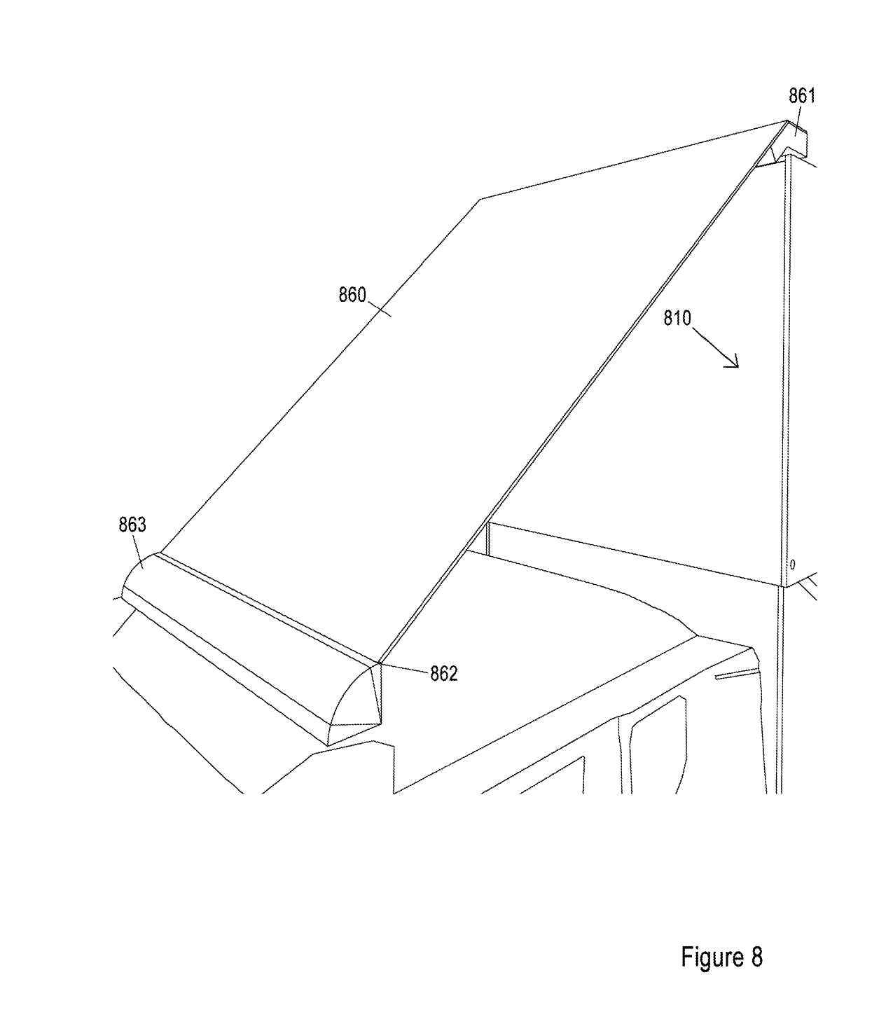

FIG. 8 illustrates a close-up perspective view of the collapsible truck trailer in the extended position, with the wind guard in its functional position. As described above in connection with FIG. 6, the wind guard comprises a flat body portion 860, a base portion 863, a pivot point 862, and a contact pad 861. As shown, the wind guard body 860 prevents air from striking the vertical surface of the front side of the upper container 810.

While there have been described herein what are considered to be preferred and exemplary embodiments of the present invention, other modifications of the invention shall be apparent to those skilled in the art from the teachings herein. For example, the relative dimensions of the device may be altered while keeping within the spirit and teachings of the invention. It is therefore desired to be secured, in the appended claims all such modifications as fall within the spirit and scope of the invention.

What is claimed is:

1. A collapsible truck trailer comprising:
a primary container having a front side, a back side, and two opposing long sides;
an upper container connected with the primary container via a lifting mechanism and a pair of lateral guide rails, the upper container having a front side, a back side, two opposing long sides, and a top surface; and
a wind guard covering the front side of the upper container, the wind guard having a base portion connected to a truck and a flat body portion, the flat body portion having a terminal portion that rests upon the upper container; and
wherein the pair of lateral guide rails comprise a vertical c-channel fixed to the upper container that is slidably engaged with a complementary vertical rail fixed to the primary container;
wherein the upper container houses the primary container in a collapsed position, and is lifted above the primary container in an extended position.

2. The collapsible truck trailer of claim 1 wherein the lifting mechanism comprises a motor, a drive belt, a drive shaft, a motorized actuator, and four pairs of intersecting lift arms, wherein a base end of the lift arms are connected with the primary container and an upper end of the arms are connected with the upper container.

3. The collapsible truck trailer of claim 2 wherein the intersecting lift arms each have two ends, wherein some ends are rotatably connected to the upper or lower containers, and other ends are slidably engaged within a horizontal track.

4. The collapsible truck trailer of claim 2 wherein the motor directly actuates four lift arms.

5. The collapsible truck trailer of claim 1 wherein the angle of the wind guard increases as the upper container is raised and decreases as the upper container is lowered.

6. The collapsible truck trailer of claim 1 wherein the terminal end of the wind guard contains a contact pad that rests upon the upper container.

7. The collapsible truck trailer of claim 1 wherein the base portion of the wind guard houses a torsion spring that exerts a constant downward force on the flat body portion of the wind guard.

8. The collapsible truck trailer of claim 1 wherein the terminal end of the flat body portion of the wind guard includes a contact pad that is in contact with the top surface of the upper container.

9. The collapsible truck trailer of claim 1 wherein the flat body portion of the wind guard is made of fiberglass.

10. A collapsible truck trailer comprising:
a primary container having a front side, a back side, and two opposing long sides;
an upper container connected with and configured to house the primary container, the upper container having a front side, a back side, two opposing long sides, and a top surface;
a wind guard covering the front side of the upper container, the wind guard having a base portion connected to a truck and a flat body portion, the flat body portion having a terminal portion that rests upon the upper container; and
a lifting mechanism that connects the primary container to the upper container, the lifting mechanism allowing the upper container to be moved between a collapsed position and an extended position.

11. The collapsible truck trailer of claim 10 wherein the lifting mechanism comprises a motor, a drive belt, a drive shaft, a motorized actuator, and four pairs of intersecting lift arms, wherein a base end of the lift arms are connected with the primary container and an upper end of the arms are connected with the upper container.

12. The collapsible truck trailer of claim 11 wherein the motor directly actuates four lift arms.

13. The collapsible truck trailer of claim 10 wherein the terminal end of the wind guard contains a contact pad that rests upon the upper container.

14. The collapsible truck trailer of claim 10 wherein the base portion of the wind guard houses a torsion spring that exerts a constant downward force on the flat body portion of the wind guard.

15. The collapsible truck trailer of claim 10 wherein the terminal end of the flat body portion of the wind guard includes a contact pad that is in contact with the top surface of the upper container.

16. The collapsible truck trailer of claim 10 wherein the flat body portion of the wind guard is made of fiberglass.

17. The collapsible truck trailer of claim 10 wherein the angle of the wind guard body increases as the upper container is raised, and decreases as the upper container is lowered.

18. A collapsible truck trailer comprising:
a primary container having a front side, a back side, and two opposing long sides;
an upper container connected with and configured to house the primary container, the upper container having a front side, a back side, two opposing long sides, and a top surface;
a lifting mechanism that connects the primary container to the upper container, the lifting mechanism allowing the upper container to be moved between a collapsed position and an extended position.

19. The collapsible truck trailer of claim 18 wherein the lifting mechanism comprises a motor, a drive belt, a drive shaft, a motorized actuator, and four pairs of intersecting lift arms, wherein a base end of the lift arms are connected with the primary container and an upper end of the arms are connected with the upper container.
